(19) United States
(12) Patent Application Publication
(10) Pub. No.: US 2025/0300339 A1
(43) Pub. Date: Sep. 25, 2025

(54) SELF-POWERED RECONFIGURABLE INTELLIGENT SURFACES UTILIZING RADIO FREQUENCY ENERGY HARVESTING

(71) Applicant: Dell Products L.P., Round Rock, TX (US)

(72) Inventors: Navjot Kaur Khaira, Kanata (CA); Tejinder Singh, Kanata (CA)

(21) Appl. No.: 18/614,932

(22) Filed: Mar. 25, 2024

(51) Int. Cl. H01P 5/04; H01P 5/08; H02J 50/12; H02J 50/20

(52) U.S. Cl. CPC H01P 5/04; H01P 5/087; H02J 50/12; H02J 50/20

(57) ABSTRACT

The technology described herein is directed towards a reconfigurable intelligent surface that harvests RF energy from incoming signals. This is accomplished through a design and implementation in which a small portion of the incoming signal energy of an impinging wave is coupled to a waveguide, with most of the signal reflected in a desired target direction. The captured portion of the signal energy is used for energy harvesting. In one implementation, the design incorporates a substrate integrated waveguide (SIW) integrated within each reconfigurable intelligent surface element (unit cell) to capture a portion of the incoming energy. The partially-coupled RF signals from the multiple reconfigurable intelligent surface elements are combined and converted to DC power using a harvesting circuit, which can be used to power the electronics in reconfigurable intelligent surfaces. A multiple battery approach is described; while one battery is charging, another battery is powering the reconfigurable intelligent surface components.

### BACKGROUND

Reconfigurable intelligent surfaces (alternatively referred to as intelligent reflective surfaces, or metasurfaces) are manmade thin reflective or refractive surfaces whose electromagnetic response can be electronically controlled. A reconfigurable intelligent surface is generally characterized by having a two-dimensional planar array of electronically controllable reflecting elements that can dynamically manipulate electromagnetic waves. These elements are capable of altering the phase shift of the reflected signals, whereby through precise adjustment of these phase shifts, sophisticated reflect beamforming can be executed.

Many reconfigurable intelligent surface designs are passive, in that they reflect the signals without needing additional amplification. However, there is still non-negligible power consumed for manipulating the phase shifts.

### BRIEF DESCRIPTION OF THE DRAWINGS

The technology described herein is illustrated by way of example and not limited in the accompanying figures in which like reference numerals indicate similar elements and in which:

FIG. 1 is an example conceptual block diagram showing an example system that includes a unit cell of a reconfigurable intelligent surface for reflecting an incoming electromagnetic signal while harvesting a portion of the incoming signal energy, in accordance with various example embodiments and implementations of the subject disclosure.

FIG. 2 is a three-dimensional representation of an example unit cell that includes a substrate integrated waveguide for capturing a portion of an incoming electromagnetic signal's energy, in accordance with various example embodiments and implementations of the subject disclosure.

FIG. 3 is enlarged three-dimensional representation of the example unit cell of FIG. 2, depicting an internal part of the substrate integrated waveguide, in accordance with various example embodiments and implementations of the subject disclosure.

FIG. 4 is a three-dimensional representation of an example unit cell that includes a substrate integrated waveguide, in which some side vias of the substrate integrated waveguide are not visible so as to illustrate an internal part of the substrate integrated waveguide, in accordance with various example embodiments and implementations of the subject disclosure.

FIG. 5 is a three-dimensional representation of an example reconfigurable intelligent surface, with an enlarged representation of one corner of the reconfigurable intelligent surface, and which also depicts a representation of part of a unit cell in that corner, in accordance with various example embodiments and implementations of the subject disclosure.

FIG. 6 is a top view representation of an example reconfigurable intelligent surface showing how energy collected from electrical energy harvesting contacts of unit cells can be used to selectively charge batteries, in accordance with various example embodiments and implementations of the subject disclosure.

FIG. 7 is a block diagram representation of example charging circuitry for charging one battery while another battery is discharging to power devices, including power for a controller/varactors of a reconfigurable intelligent surface, in accordance with various example embodiments and implementations of the subject disclosure.

FIG. 8 is a representation of an example multistage rectifier that can be used in the charging circuitry of FIG. 7, in accordance with various example embodiments and implementations of the subject disclosure.

FIG. 9 is an example graphical representation of harvested DC voltage using different stage rectifiers, in accordance with various example embodiments and implementations of the subject disclosure.

FIG. 10 is an example graphical representation of efficiency versus received radio frequency power between different stage rectifiers, in accordance with various example embodiments and implementations of the subject disclosure.

FIG. 11 is a flow diagram showing example operations related to charging a first battery with combined harvesting energy, while powering a controller from a second battery to control tuning elements of unit cells, in accordance with various example embodiments and implementations of the subject disclosure.

### DETAILED DESCRIPTION

The technology described herein is generally directed towards a reconfigurable intelligent surface that includes an integrated energy harvesting circuit, where in general, energy harvesting refers to extracting energy from the surrounding environment. As described herein, the harvested energy is used to power the components of the reconfigurable intelligent surface, including for tuning the phases of the unit cells, in order to controllably redirect an incoming electromagnetic wave. In this way, the harvested electromagnetic energy can partially or fully self-power the reconfigurable intelligent surface module to enhance network energy efficiency. At the same time, energy harvesting is accomplished by only capturing part of the incoming signal energy, with most of the incoming signal energy reflected in a controlled shape and/or direction.

In one implementation, at the unit cell level in a reconfigurable intelligent surface, a small portion of the incident wave is coupled to a substrate integrated waveguide. In turn, at least some of the portion is output from the substrate integrated waveguide to an electrical energy harvesting contact. The contacts from the (typically many) unit cells are coupled to charging circuitry; more particularly, the separately harvested energy portions are coupled via the contacts to a radio frequency (RF) power combiner, which outputs the combined energy to an impedance matching circuitry, and then to a rectifier to obtain DC power. The use of RF power combiners eliminates or helps reduce the need for various groups of multiple rectifiers and impedance matching networks, effectively minimizing energy loss attributed to RF impedance mismatches. A controller (e.g., control unit) manages the signal reception for energy harvesting, and also functions as the bias controller for the reconfigurable intelligent surface's unit-cells. In this way, a small amount of an incoming signal is coupled to the substrate integrated waveguide, which can be output as harvested energy. Note that the amount of coupled energy into the substrate integrated waveguide, and at the electrical energy harvesting contact, can be adjusted during design of a reconfigurable intelligent surface.

In one implementation, two distinct batteries are available, one for charging and one for providing power for the reconfigurable surface tunable components. That is, one battery is charged with the RF coupled harvested energy, while the other, previously charged battery, supplies power to the electronic components. A power management module (an intelligent device) monitors the battery power levels, and based on at least one of the levels satisfying a threshold level, simultaneously switches the roles of the batteries from discharging power to charging, and vice-versa, adopting a “harvest-store-use” model as opposed to a more traditional “harvest-use” model.

It should be understood that any of the examples and/or descriptions herein are non-limiting. Thus, any of the embodiments, example embodiments, concepts, structures, functionalities or examples described herein are non-limiting, and the technology may be used in various ways that provide benefits and advantages in communications and computing in general.

Reference throughout this specification to “one embodiment,” “an embodiment,” “one implementation,” “an implementation,” etc. means that a particular feature, structure, characteristic and/or attribute described in connection with the embodiment/implementation can be included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, characteristics and/or attributes may be combined in any suitable manner in one or more embodiments/implementations. Repetitive description of like elements employed in respective embodiments may be omitted for sake of brevity.

The detailed description is merely illustrative and is not intended to limit embodiments and/or application or uses of embodiments. Furthermore, there is no intention to be bound by any expressed or implied information presented in the preceding sections, or in the Detailed Description section. Further, it is to be understood that the present disclosure will be described in terms of a given illustrative architecture; however, other architectures, structures, materials and process features, and steps can be varied within the scope of the present disclosure.

It also should be noted that terms used herein, such as “optimize,” “optimization,” “optimal,” “optimally” and the like only represent objectives to move towards a more optimal state, rather than necessarily obtaining ideal results. Similarly, “maximize” means moving towards a maximal state (e.g., up to some processing capacity limit), not necessarily achieving such a state, and so on.

It will also be understood that when an element such as a layer, region or substrate is referred to as being “on” or “over” “atop” “above” “beneath” “below” and so forth with respect to another element, it can be directly on the other element or intervening elements can also be present. In contrast, only if and when an element is referred to as being “directly on” or “directly over” another element, are there no intervening element(s) present. Note that orientation is generally relative; e.g., “on” or “over” can be flipped, and if so, can be considered unchanged, even if technically appearing to be under or below/beneath when represented in a flipped orientation. It will also be understood that when an element is referred to as being “connected” or “coupled” to another element, it can be directly connected or coupled to the other element or intervening elements can be present. In contrast, only if and when an element is referred to as being “directly connected” or “directly coupled” to another element, are there no intervening element(s) present.

The following detailed description is merely illustrative and is not intended to limit embodiments and/or application or uses of embodiments. Furthermore, there is no intention to be bound by any expressed or implied information presented in the preceding sections, or in the Detailed Description section.

One or more example embodiments are now described with reference to the drawings, in which example components, graphs and/or operations are shown, and in which like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details, and that the subject disclosure may be embodied in many different forms and should not be construed as limited to the examples set forth herein.

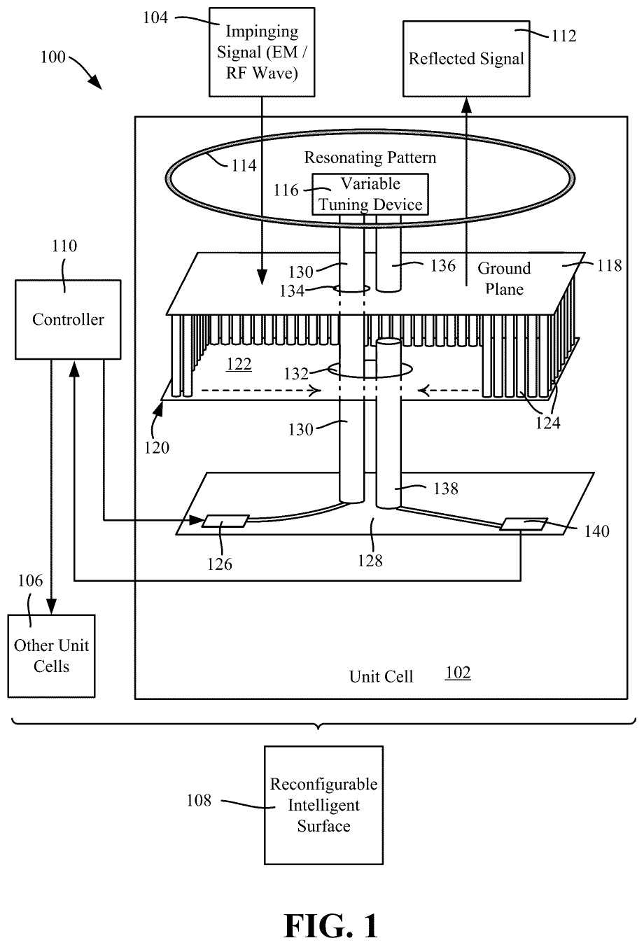

FIG. 1 is a conceptual depiction of an example system 100 including a unit cell 102 that redirects (reflects or refracts) an incoming (impinging) signal 104, while also capturing a portion of the incoming signal energy to provide power for harvesting from the captured portion of energy. The unit cell 102, in conjunction with other unit cells 106, forms a reconfigurable intelligent surface 108.

The reconfigurable intelligent surface 108 is coupled to or otherwise incorporates a controller 110 that controls the phase shifts of the unit cell 102 and the other unit cells 106. This allows the incoming electromagnetic wave/signal 104 to be redirected (reflected or refracted) as a beam 112 that can be shaped and steered in a desired direction. As will be understood, the unit cells 102 and 106 of the reconfigurable intelligent surface 108 have the ability to extract a fragment of the incident wave for harvesting energy to be used (in part) to change the unit cells' phases, while reflecting most of the incident wave, thereby ensuring sufficient reflective power and a modifiable reflective phase for the formation of optimal reflection configurations.

In one implementation, the unit cell 102 includes a resonating pattern 114 of metallic elements, such as including a generally ring-shaped resonator configured to resonate when the incoming electromagnetic (EM)/radio frequency (RF) wave 104 is impinging on the unit cell 102, such as an RF signal near or within the millimeter wavelength, e.g., (above 25 gigahertz). In general, the metallic resonating pattern 114 is designed to resonate at a frequency that corresponds to the frequency of the incoming signal. As set forth herein, a unit cell 102 can have a resonating pattern 114 of any suitable shape (e.g., square, rectangular, concentric ring-shape, coupled circles and so on) that resonates at a corresponding frequency of the incoming signal, and is thus not limited to any particular pattern. Note that in the examples herein, a unit cell 102 is designed for operation at 28 GHz; notwithstanding, the technology described herein can be easily extended to other frequency ranges.

In general, the metallic resonating pattern 114 is designed for operation at a desired resonance frequency that corresponds to the frequency of the incoming signal 104. A variable tuning device 116 (e.g., surface mounted inside the resonating pattern's ring, which can be a varactor, a PIN diode, an array of fixed capacitors, an array of fixed inductors, or a capacitance tuning device with the capability of changing the capacitance of the unit cell 102) is designed for operation at the desired resonance frequency, with a change in capacitance of the variable tuning device 116 determined by bias voltage as applied by the controller 110. The change in capacitance makes the phase of the unit cell 102 reconfigurable. In this way, each unit cell such as the unit cell 102 is capable of offering a reconfigurable phase to the incoming EM signal when provided with different voltage levels to the variable tuning device 116. When the phases of the individual unit cells are appropriately chosen and voltage-controlled by the controller 110 via the variable tuning device 116, the various phases modify the reflected electromagnetic wave, such as to result in constructive interference in a desired reflection direction. Note that such a varactor can be integrated into the unit cell, or can be a commercial product coupled (e.g., surface mounted) to the unit cell. Further, instead of or in addition to varactors, integrated tuning can be accomplished with PIN diodes, as well as any mechanism that can tune a unit cell's phase.

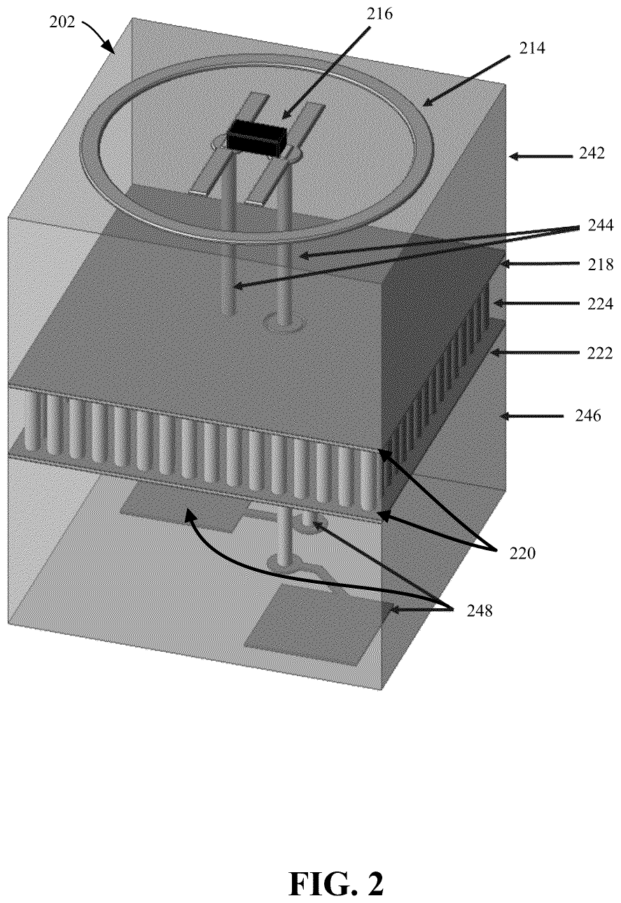

Also represented in FIG. 1 is the ground plane 118 of the unit cell 102. In one implementation, the ground plane 118 also acts as the top surface of a substrate integrated waveguide 120. As described with reference to FIGS. 2-4, the substrate integrated waveguide 120 captures a portion of the energy of the incoming EM signal.

The substrate integrated waveguide 120 includes a metal bottom layer 122, with the interior of the substrate integrated waveguide 120 enclosed by metal side vias (collectively 124), which are configured (based on the signal's wavelength) as separated metal-filled via holes, or sidewalls, with respect to not letting the portion of the incoming EM signal leak out (to ensure accurate waveguide operation at the designed frequency corresponding to the incoming electromagnetic signal). Note that some of the side vias in the front view of the substrate integrated waveguide 120 have been intentionally omitted to help view the interior of the substrate integrated waveguide 120; the left and right dashed arrows inside the substrate integrated waveguide 120 are intended to convey that the metal side vias 124 fully extend across the front side, as do the metal side vias 124 on the other sides.

To provide bias voltage to the variable tuning device 116, the controller 110 is coupled to a DC voltage contact 126, shown in the drawings as a pad on a bottom layer 128 of the unit cell 102. A voltage or current 130 extends through a lower opening 132 of the metal bottom layer 122 of the substrate integrated waveguide 120, and through an upper opening 134 in the ground plane 118 (the upper metal layer of the of the substrate integrated waveguide 120) of the unit cell 102/the reconfigurable intelligent surface 108, to supply positive bias voltage from the DC voltage contact 126 to a positive terminal of the variable tuning device 116. The varactor's negative terminal terminates at the ground plane by way of the via/conductor 136.

To obtain the energy from the portion of the signal energy captured by the substrate integrated waveguide 120, an RF-coupled via probe 138 extends into the substrate integrated waveguide 120 through the bottom opening 132. This picks up at least some of the portion of the EM energy, and provides the picked up energy as electrical output to an electrical energy harvesting contact 140/(e.g., in the form of a pad) to serve as an energy source. As described herein, this energy source is combined with the energy similarly harvested from other unit cells 106 to provide power to the components of the reconfigurable intelligent surface 108.

In general, because of their ability to achieve lower energy use, reconfigurable intelligent surface-assisted communications are preferable to using active relay systems. The technology described herein is directed to a hardware method/circuit for use with reconfigurable intelligent surface elements, to provide self-sustaining reconfigurable intelligent surface operation through energy harvesting from incoming electromagnetic signals. Such self-sufficiency is achievable if the reconfigurable intelligent surface's electronic components' average power consumption remains below a few microwatts. Note however that while the signal-to-noise ratio (SNR) remains consistent across reconfigurable intelligent surface-aided communication links regardless of whether the transmitter and receiver swap roles, the efficiency of energy harvesting does not, whereby the reconfigurable intelligent surface should be positioned near the transmitter for more optimal energy collection.

FIGS. 2-4 provide additional, three-dimensional views and details of a unit cell 202 of a reconfigurable intelligent surface, which shows the components in a stack of metallic layers and dielectric layers. In FIGS. 2-4, in general labeled components that are similar to those of the conceptual depiction of FIG. 1 are labeled 2xx instead of 1xx.

Thus, as shown in FIG. 2, a reflective element pattern 214 and a varactor 216 (representative of one example type of the variable tuning device 116 of FIG. 1) are shown at the top of the unit cell 202 stack, supported by a top dielectric substrate 242. The vias for varactor biasing are collectively labeled 244; (note that the unit cell stack can be reoriented such that what can be seen as the left and right bias vias in FIG. 1 can be reversed).

The ground metal layer 218 is beneath the top dielectric substrate 242, and in this example implementation also serves as the top of the substrate integrated waveguide 220. The metal hole/sidewall vias 224 of the substrate integrated waveguide 220 are vertically oriented between the ground metal layer 218 and the bottom metal layer 222 of the substrate integrated waveguide 220. These layers are supported by a bottom substrate 246.

A substrate integrated waveguide is essentially a waveguide that is integrated into a dielectric substrate. Substrate integrated waveguides are a form of transmission line used in microwave and millimeter-wave circuits. They effectively bridge the gap between conventional rectangular waveguides and planar circuits. A substrate integrated waveguide is bounded by two parallel metal plates (top 218 and bottom 222), with the sides of the top plate 218 typically perforated with an array of metal-filled via holes. The via holes facilitate the inclusion of the metal side vias 224 that act as sidewalls of the waveguide, confining the electromagnetic waves between them. Substrate integrated waveguides offer several advantages over the conventional waveguides, including that they enable waveguide structures to be incorporated into standard planar circuit technologies, making them suitable for compact and integrated circuit designs. By integrating the waveguide into the substrate, substrate integrated waveguides structures can be fabricated using conventional printed circuit board (PCB) or semiconductor manufacturing techniques. Additionally, they can operate over a wide frequency range, including at high frequencies such as millimeter wave frequencies, making them suitable for various applications.

As also shown in FIG. 2, the metal contacts/pads for the varactor DC bias to the varactor and the EM signal and are collectively labeled 248. These pads 248 are beneath (at least in part) the bottom substrate 246 to facilitate straightforward external electrical coupling thereto.

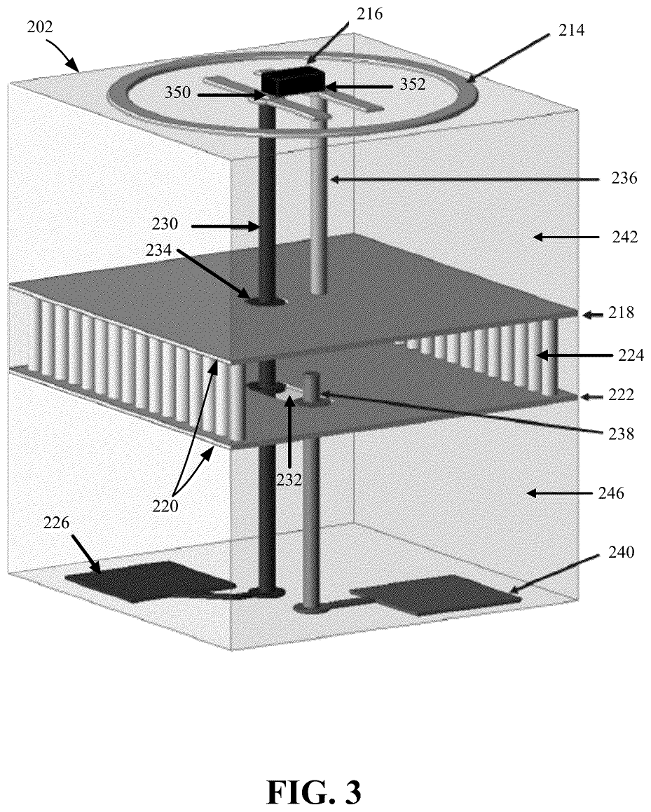

FIG. 3 is another three-dimensional view of the unit cell 202 of FIG. 2, in which some of the sidewalls 224 are omitted to allow the inside of the substrate integrated waveguide 220 to be viewed. As can be seen, most of the labeled components correspond to those described with reference to FIGS. 1 and 2, and in general are not described again for purposes of brevity. Note, however, that unlike FIG. 2, the inside of the substrate integrated waveguide 220 is visible, and therefore shows the coupled via probe 238 extending into the substrate integrated waveguide 220 through the bottom opening 232.

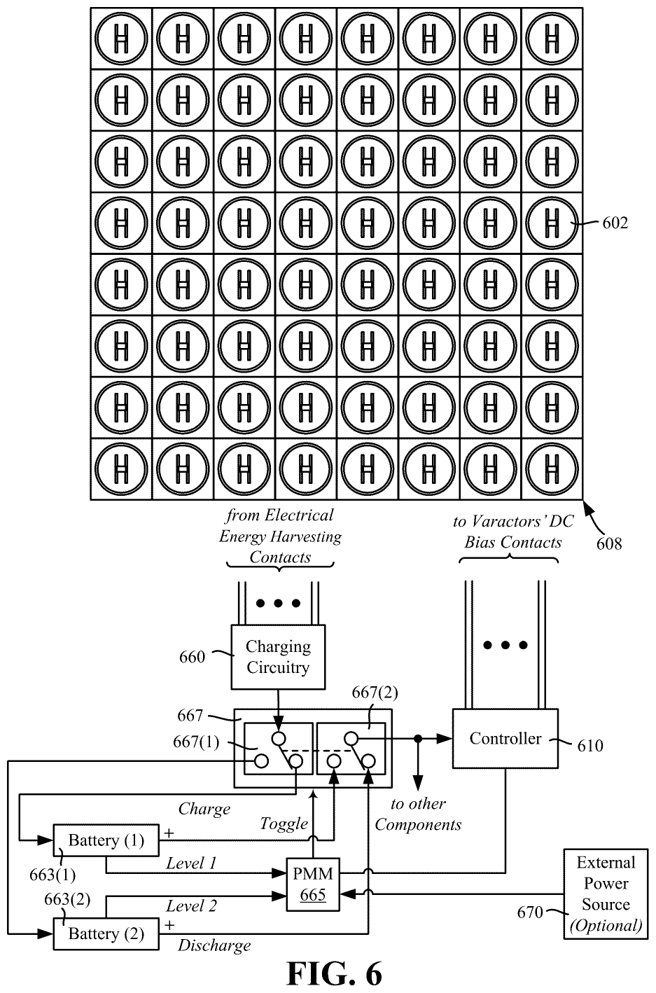

In general, substrate integrated waveguides channel the sampled signal, and have advantages over alternatives. For example, unlike microstrips, substrate integrated waveguides confine electromagnetic waves within their boundaries, minimizing potential interference. Furthermore, the intersection of vias with microstrips can induce unintended radiation, a scenario counterproductive for a unit cell design. Still further, the level of coupling between the substrate integrated waveguides and the meta-atom can be adjusted by modifying the substrate integrated waveguide's cutoff frequency, or by altering the distance from the via to the substrate integrated waveguide's edges. As described with reference to FIGS. 6-10, the sampled signal at each reconfigurable intelligent surface element can be harvested as energy.

FIG. 3 also shows the positive and negative terminal locations 350 and 352, respectively, of the varactor 216. Further, in FIG. 3, the DC bias voltage pad 226 and the electrical sensing contact (EM coupled signal readout pad) 240 are shown as positioned at a layer level separated from the substrate integrated waveguide's bottom metal plate 222 by the dielectric substrate 246.

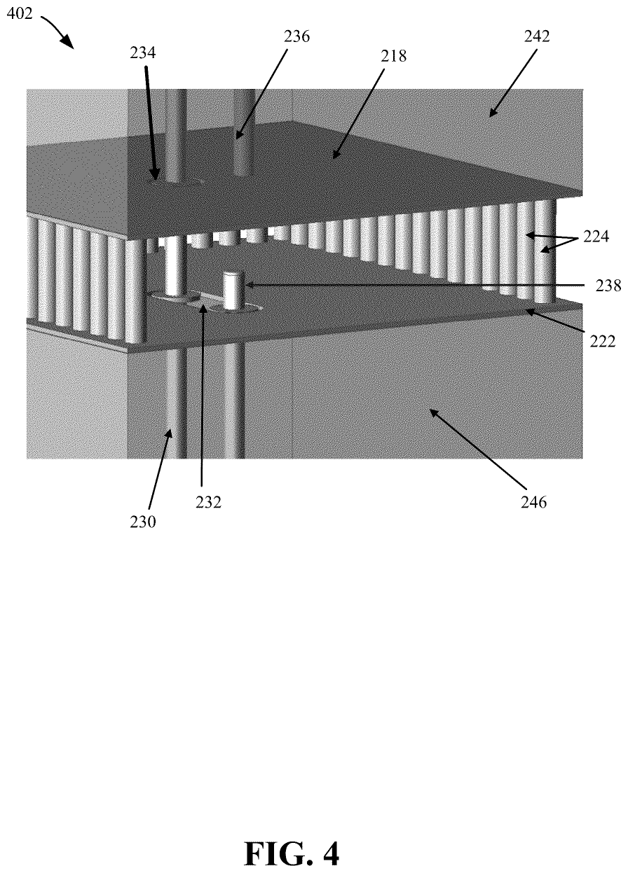

FIG. 4 is an enlarged view of a section 402 of the substrate integrated waveguide of FIG. 3, highlighting the coupled via probe 238. In one implementation, the reconfigurable intelligent surface ground plane 218 acts as the top metal plane for the substrate integrated waveguide structure, which is enclosed by another metal layer 222 separated by a dielectric 246, as well as enclosed on the sides by the metal vias 224. Under the influence of the incoming signal, the EM energy flows through the voltage or current via 230 of the varactor 214 (FIG. 3). Some of the energy is coupled to the substrate integrated waveguide 220 when the via 230 passes through it.

The varactor via 230, which passes through the ground plane 218 is disconnected from ground by an annular slot 234. This annular slot allows for RF coupling of the incident wave to the substrate integrated waveguide structure. The coupled signal is read/sensed at the output by the coupled via probe 238. The extent of RF coupling can be fine-tuned by varying the annular slot's diameter and the characteristic dimensions of the coupling waveguide. In other words, the probe can be designed at a specific certain distance position/distance to capture part of signal; note that a probe is only one suitable coupling mechanism, and need not be a via as shown in the examples.

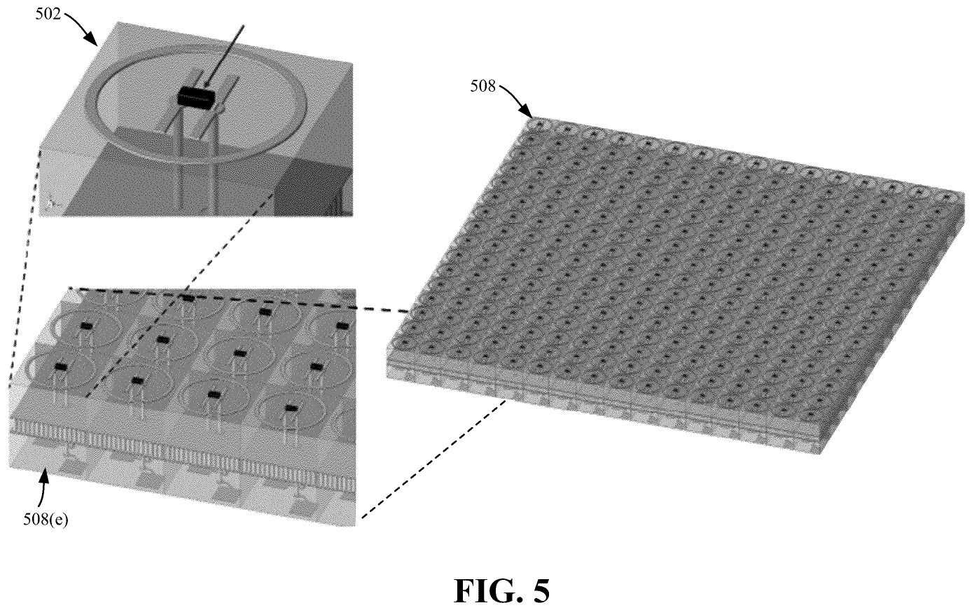

The reconfigurable intelligent surface is formed by arranging multiple unit-cells in a 2D m×n array. A 3D view of a reconfigurable intelligent surface 508 with 16 rows and 16 columns is shown in FIG. 5. An enlarged view 508 (c) from a section of the reconfigurable intelligent surface 508, is shown to highlight the geometry. FIG. 5 also shows the enlarged partial view of a unit cell 502, to better illustrate the reflective element patterned on the metallic layer on top substrate, each loaded with a surface mount varactor diode. One or more PIN diodes can also be used to the vary phase of a unit cell.

The element size and the spacing between elements are around a half wavelength. Using a smaller element size and spacing (for example around a quarter of wavelength or even smaller) can allow for better approximation of the necessary phase profile and improve beam redirecting performance, at the cost of larger interelement coupling and increased fabrication costs due to smaller feature sizes and tighter fabrication tolerances. In many cases, half wavelength provides an adequate middle ground for realizing the beam steering performance while keeping the fabrication costs low.

As is understood, to obtain the desired reconfigurable reflection, an electromagnetic wave at a resonance frequency within the operational band is transmitted to impinge on the unit cells. The reflected wave is modulated through varactor capacitance adjustments.

FIG. 6 is a top view representation of an example 8×8 array 608 of sixty-four unit cells, each generally corresponding to the example unit cell 202 of FIGS. 2-4. One of the unit cells 602 is labeled in FIG. 6. As represented in FIG. 6, a controller 610 is coupled to provide respective varactor biasing voltages to the respective unit cells' bias contacts coupled to the respective varactors (and/or other variable tuning devices). Further, the controller 610 is coupled to a battery (currently the battery (2) 663(2) in the example of FIG. 6) to obtain the power needed to adjust the varactors.

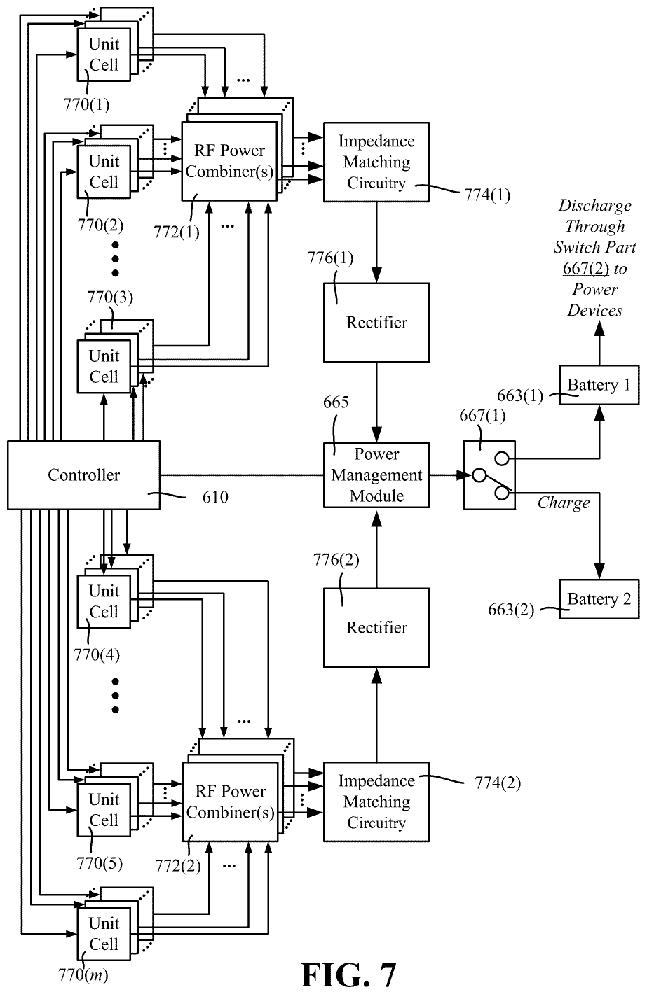

As described herein, charging circuitry 660 charges a selected one of the batteries (currently the battery (1) 663(1) in the example of FIG. 6) while the other battery 663(2) powers the controller 610 and any other power consuming components of the reconfigurable intelligent surface, such as memory (if not internal to the controller) for storing different sets of the unit cell's phases, communication circuitry for obtaining the different sets of the unit cell's phases, power consuming devices of the charging circuitry 660 (further described with reference to FIG. 7), and so on. The reconfiguration instructions can be received wirelessly at the controller 610, which then provides the corresponding voltage biases to the individual varactors/PIN diodes/other variable tuning devices of the reconfigurable intelligent surface elements.

A power management module (PMM/a power management unit (PMU)) 665 monitors the charge levels of the batteries 663(1) and 663(2), and, for example, if the battery currently being discharged to provide power satisfies a discharge threshold level, actuates a double-pole, double-throw (DPDT) switch 667 (represented by jointly-actuated internal switch parts 667(1) and 667(2)), such that the batteries 663(1) and 663(2) swap roles, that is, the battery 663(1) starts powering the components while the battery 663(2) begins recharging; (instead of a double-pole, double-throw switch, separate switches can be used and jointly toggled by the power management module 665). Note that if the battery 663(1) is fully charged (or deemed sufficiently charged to a threshold charge level), this can also cause the power management module 665 to toggle the DPDT switch 667. An optional external power source 670 may be used, if available, in the event that the battery being charged is still too low to take over for a fully or mostly discharged battery. The optional external power source 670, if present, can also be used to assist in charging the batteries in such a condition.

By way of example, consider that two batteries are normally able to self-power the reconfigurable intelligent surface components, (that is, one battery at a time). However, a large amount of reconfiguring may occasionally be needed, whereby the one battery may not be able to be recharged quickly enough while the other battery is rapidly discharged. The external power 670 source may be switched in (e.g., by the power management module 665) in such a condition. It is also possible to have more than two batteries, so that, for example, in very low usage conditions (e.g., late at night) only some of the unit cells can be reconfigured for redirection, and then only relatively infrequently, whereby the batteries not in use (e.g., two of three batteries) can be fully charged while the remaining battery provides power until a fully charged battery can change roles with it.

FIG. 7 shows details of example charging circuitry, including the power management module 665, the switch part 667(1) that is toggled for selective charging, and the two batteries 663(1) and 663(2). In the example of FIG. 7, the unit cells are represented as subgroups 770(1)-770(m), such as, for example, if each subgroup is a row of the m×n array of unit cells.

In this example, the harvested energy at the electrical energy harvesting contacts of the unit cells 770(1)-770(m) are electrically coupled to one or more RF power combiners 772(1) and one or more RF power combiners 772(2), which combine the harvested energy. In turn, the combined energy is input to impedance matching circuitry (e.g., networks) 774(1) and 774(2), respectively, and then to respective rectifiers 776(1) and 776(2). Note that the power is combined from the array of cells/subgroups 770(1)-770(m) of the array, and (although not depicted as such in FIG. 7) there can be only a single combiner, or there can be multiple combiners that feed to a next combiner and so on; alternatively there can be multiple combiners (e.g., one per row or column of cells), that feed to multiple impedance matching networks.

The power management module 665 receives the DC power from the rectifiers 776(1) and 776(2), and uses the combined power to charge the battery currently coupled to the power management module 665 by the switch 667, which is the battery 663(2) in the example of FIG. 7.

To summarize, the generated DC power is used to charge batteries (or alternatively capacitors) serving as energy storage devices. These devices operate in a cyclical manner; one charges while the other discharges to power the control chips and rectifying circuits. Upon one device being (e.g., fully) charged and/or the other sufficiently depleted, they switch roles. A power management module/device (or unit, PMU) oversees the decision to either store the harvested electricity or use the stored energy. One implementation of the system thus utilizes a dual-battery configuration with this power management system, employing a harvest-store-use model over a direct harvest-use approach. With the harvest-store-use strategy, the system is outfitted with an energy storage solution or rechargeable battery that holds the harvested electricity. This arrangement allows for the storage of surplus energy when the amount harvested exceeds the system's energy use for subsequent utilization.

As described herein, each unit cell possesses dual functionalities, namely a unit cell can harvest energy and reflect incident electromagnetic waves. Denote the phase and amplitude responses of a specific (m, n)^{th} unit cell of reconfigurable intelligent surface by θ_{m,n} and A_{m,n}, respectively. The portion of power that is reflected back is given by A_{m,n}², whereas the portion that is absorbed by the cell for energy harvesting is given by (1−A_{m,n}²); (disregarding the ohmic and other additional losses).

Consider the number of unit cells in an m×n reconfigurable intelligent surface panel as K_{c}, and P_{c} as accommodating the power consumption of the semiconductor tuning component (e.g., PIN diode/varactor) on each cell (K_{c}) and its accompanying control chip (P_{c}). Moreover, P_{rect} is the power usage for each of the K_{rect} rectifying circuits. For the total reconfigurable intelligent surface power consumption, denoted by P_{RIS}, by assuming one semiconductor component per unit cell:

$${P}_{RIS} = {K}_{c} {P}_{c} + {K}_{rect} {P}_{rect}$$

Within this framework, P_{c} signifies an aggregate power consumption rate (mean value). For instance, denoting the chip's static power usage as P_{static}, its dynamic consumption as P_{dynamic}, and the proportion of time the reconfigurable intelligent surface requires reconfiguration (determined by both the switching frequency and the duration of reconfiguration) as N_{reconfig}, the following relationship is established:

$${P}_{c} = {P}_{static} + {N}_{r econfig} {P}_{dynamic}$$

If the total incident power on the (m, n)^{th} unit element is Pi_{m,n}, the absorbed power of the (m, n)^{th} unit element is Pabs_{m,n}:

$${P}_{a b {s}_{m , n}} = ( 1 - {A}_{m , n}^{2} ) P {i}_{m , n}$$

Therefore, the cumulative power absorption by the reconfigurable intelligent surface within a single communication interval amounts to the aggregate of Pabs_{m,n} for every unit element. Defining E, within the range of (0,1) as the efficiency of converting RF energy to DC power, a metric consistent across the rectifying circuits in use. The overall power harvested by the reconfigurable intelligent surface is thus calculated as follows:

$${P}_{h a r v} = ϵ {\sum }_{m = 1}^{{K}_{x}} {\sum }_{n = 1}^{{K}_{y}} {P}_{a b {s}_{m , n}}$$

To achieve perpetual (self-sustaining) functionality of the reconfigurable intelligent surface, the harvested power needs to be at least equal to the operational requirements of the reconfigurable intelligent surface:

Pₕₐᵣᵥ≥P_{RIS}

Determining the contributors to energy usage within the reconfigurable intelligent surface electronics is significant in identifying technological improvements in ultra-low power electronics to achieve self-sustaining operations. Consideration needs to be given to the strategic placement of the reconfigurable intelligent surface and adjusting the amplitude and phase responses of its unit cells to optimize the overall signal-to-noise ratio (SNR), ensuring autonomous operation (typically) based on harvested power. Note that higher RF signal energy is available closer to the transmitter, whereby improved energy harvesting can be achieved if the reconfigurable intelligent surface is installed in closer proximity to the transmitter.

The power-consuming parts of a reconfigurable intelligent surface include semiconductor components in the reconfigurable intelligent surface's unit cells, which use power based on static and dynamic factors. Static consumption results from the continuous energy drain stemming from leakage currents caused by bias voltages in a stable operational state. Dynamic consumption, significant during state transitions, is caused by the charging and discharging of capacitors to adjust the unit cells' phase and amplitude responses, and is less impactful in low mobility environments. In reconfigurable intelligent surface deployments with energy harvesting capability, the use of low power PIN diodes/varactors or technologies such as field-effect transistors (FETs) and radio frequency microelectromechanical systems (RF MEMS), in which the static power usage is minimal, is likely beneficial.

The modules for harvesting energy also consume power. In the context of converting RF energy to DC power, for energizing the reconfigurable intelligent surface as described herein, corporate feed networks can be used. These networks channel the energy collected from multiple unit cells towards a singular (or a low number of rectifiers) rectification system, rather than assigning a separate rectifier for each unit cell. The design of these rectifying circuits can vary; they can be passive, which essentially have minimal power usage, or active, featuring active diodes that enhance conversion efficiency at the cost of a noticeable increase in power consumption.

The reconfigurable intelligent surface configuration network also uses power, as it needs external commands to change its setup, receiving signals wirelessly for processing by its circuitry. This includes the controller (e.g., a microcontroller) for adjusting the tuning components such as PIN diodes or varactors. The circuits handling these signals consume power through leakage currents and transistor activations, and often use asynchronous logic to reduce power use.

Each reconfigurable intelligent surface component is selected for a specific frequency, with impedance matching achieved through a resonator circuit tuned to this frequency, enhancing the power transfer efficiency between the reconfigurable intelligent surface components and the multiplier. The efficiency of RF energy harvesting depends on the power of the transmitted signal, its wavelength, and distance between the RF source and the reconfigurable intelligent surface panel.

The circuits employed for impedance matching networks in energy harvesting circuits include LC (inductor/capacitor) networks (which typically are passive but can be active devices). The function of a rectifier is to convert the input RF signals (AC type) captured by reconfigurable intelligent surface elements into DC voltage, with the challenge being to generate a battery-like voltage from very low input RF power. In a rectifier circuit, the diode serves as a significant element, because the effectiveness of rectification is largely influenced by the diode's characteristics, such as its saturation current, junction capacitance, and conduction resistance. Schottky barrier diodes, known for their lower voltage thresholds, can enhance efficiency by minimizing harmonic signal generation.

Thus, selecting the appropriate diode matters in rectifier design, as achieving peak efficiency at a specific power level depends on the diode's characteristics. Because the peak voltage of the AC electromagnetic signal absorbed from the reconfigurable intelligent surface elements is generally much smaller than the diode threshold, diodes with the lowest possible turn on voltage may be preferable. Schottky diodes use a metal-semiconductor junction instead of a semiconductor-semiconductor junction. This allows the junction to operate much faster, and gives a forward voltage drop of as low as 0.15 V, allowing for high efficiency at significantly lower input power levels (as low as −20 dBm). Different commercially available diodes can be used, including those appropriate for rectifiers at millimeter wave frequencies.

A Dickson voltage rectifier (an active circuit) can provide high energy efficiency, where each stage in a multistage Dickson voltage rectifier is a modified voltage multiplier, arranged in series. Even higher energy efficiency can be achieved if the Dickson voltage rectifier is made using fully depleted silicon-on-insulator (FD-SOI) technology. There is a direct correlation between the output voltage and the number of stages, although practical limits cap the maximum stages and, consequently, the output voltage.

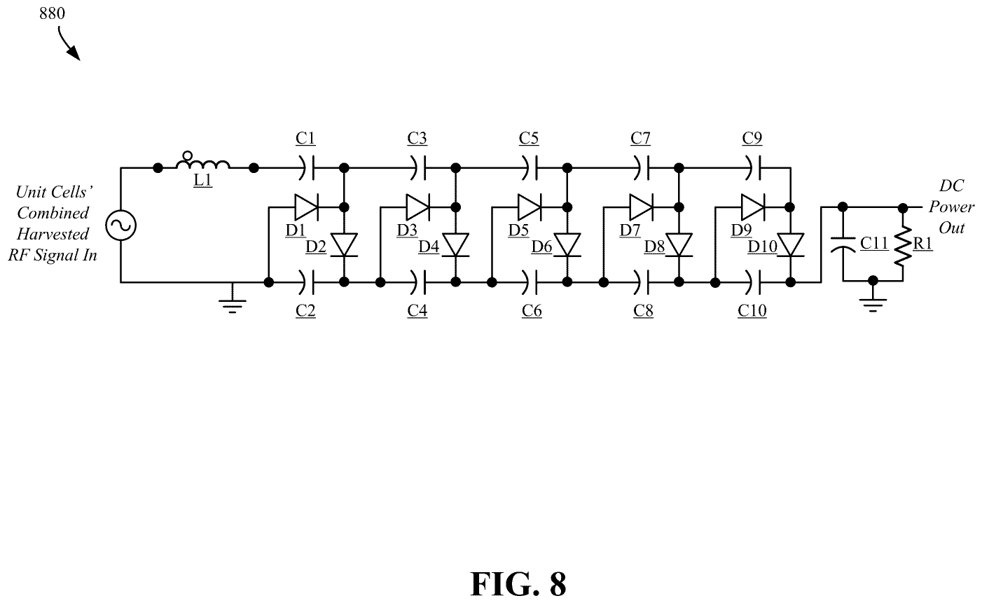

The output voltage in energy harvesting circuits is significantly affected by the number of rectifier stages. To evaluate the efficiency of rectifiers with varying stages, similar designs for 1-stage, 3-stage, 5-stage, 7-stage, and 9-stage voltage rectifiers were created and simulated. An example (passive) five-stage rectifier 880 of FIG. 8 is shown that was evaluated with respect to converting the unit cells' combined harvested RF signal energy into DC output.

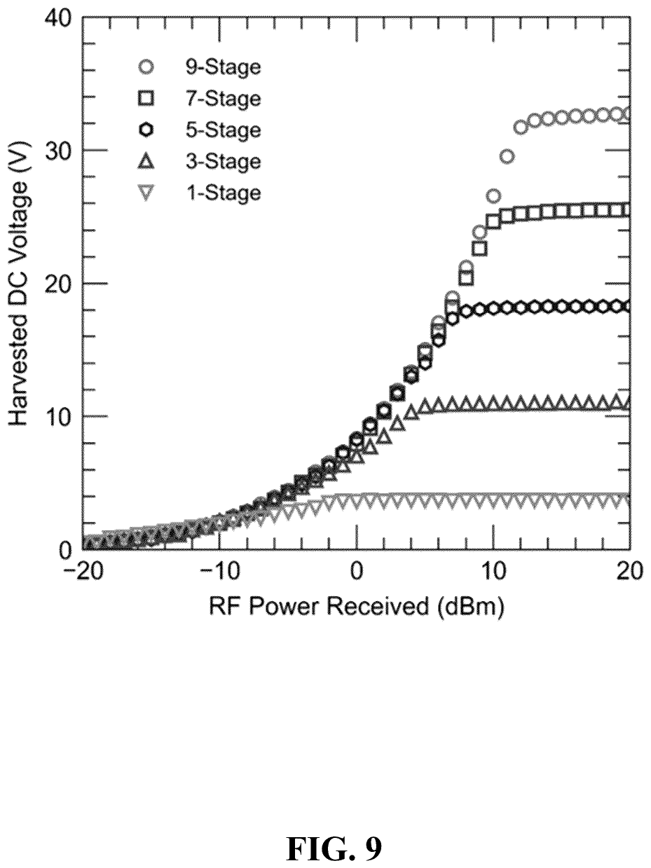

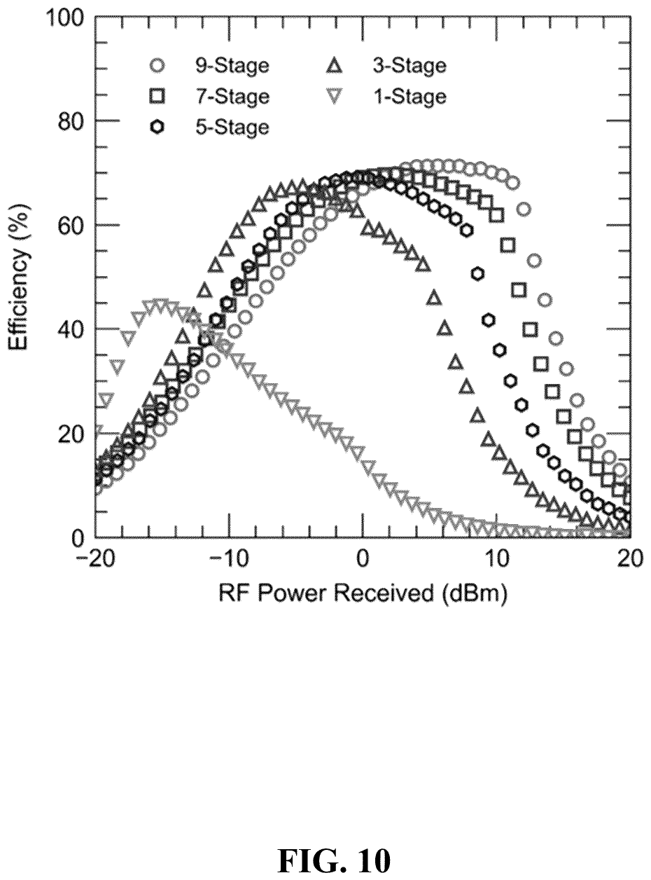

The simulation results for harvested DC voltage and the efficiency, varied across input RF powers from −20 to 20 dBm and circuit stages from 1 to 9, are shown graphically in the examples of FIGS. 9 and 10, respectively. It can be seen that efficiency improves with the addition of more stages. This improvement also moves the efficiency peak towards the higher power levels. By increasing the number of stages, a higher voltage can be achieved, although a corresponding increase in power loss is also introduced into the low power region. As the input RF power is a factor, the simulation results also show that the closer in proximity that a reconfigurable intelligent surface is installed with respect to the signal transmitter, the more enhanced the energy harvesting efficiency.

One or more example embodiments can be embodied in a system, such as described and represented herein. The system can include a reconfigurable intelligent surface that reflects an incoming electromagnetic signal as a reflected electromagnetic signal, and respective unit cells of the reconfigurable intelligent surface. The respective unit cells can include respective substrate integrated waveguides configured to capture respective portions of energy of the incoming electromagnetic signal, respective electrical contacts, and respective coupling probes that extend into the respective substrate integrated waveguides to transfer electrical energy to the respective electrical contacts based on the respective portions of energy captured in the respective substrate integrated waveguides. Electrical charging circuitry can be coupled between the respective electrical contacts and a battery, in which the electrical charging circuitry can be configured to convert the electrical energy from the respective electrical contacts to direct current that charges the battery.

The battery can be a first battery, and the system further can include a controller, and a switch that is operational in a first state to couple the first battery to the electrical circuitry, in conjunction with a second battery providing power to the controller and to respective variable tuning devices of the respective unit cells; the respective variable tuning devices can be controllable by the controller to determine at least one of: shape, direction, or amplitude of the reflected electromagnetic signal. The switch can be operational in a second state to couple the second battery to the electrical charging circuitry, in conjunction with the first battery providing power to the and the controller and to respective variable tuning devices of the respective unit cells.

The battery can be a first battery, and the system further can include a switch that is operational in a first state to couple the first battery to the electrical circuitry, in conjunction with a second battery providing power to respective variable tuning devices of the respective unit cells. The switch can be operational in a second state to couple the second battery to the electrical charging circuitry, in conjunction with the first battery providing power to the respective variable tuning devices of the respective unit cells; the system further can include a power management device (module/unit) that toggles the switch between the first state and the second state based on a first level of charge of the first battery and a second level of charge of the second battery.

The system further can include a power source that is coupled to a controller of the reconfigurable intelligent surface and to the respective variable tuning devices to act as a backup power source to the reconfigurable intelligent surface upon the first level of charge of the first battery satisfying a first discharge threshold level, and the second level of charge of the second battery first battery satisfying a second discharge threshold level.

The electrical charging circuitry can include a radio frequency power combiner comprising inputs electrically coupled to the respective electrical contacts. The electrical charging circuitry can include an impedance matching circuit electrically coupled to an output of the radio frequency power combiner. The electrical charging circuitry can include a rectifier coupled to an output of the impedance matching circuit.

The rectifier can be a multistage rectifier. The rectifier can include a Dickson voltage rectifier. The rectifier can include a fully depleted silicon-on-insulator rectifier.

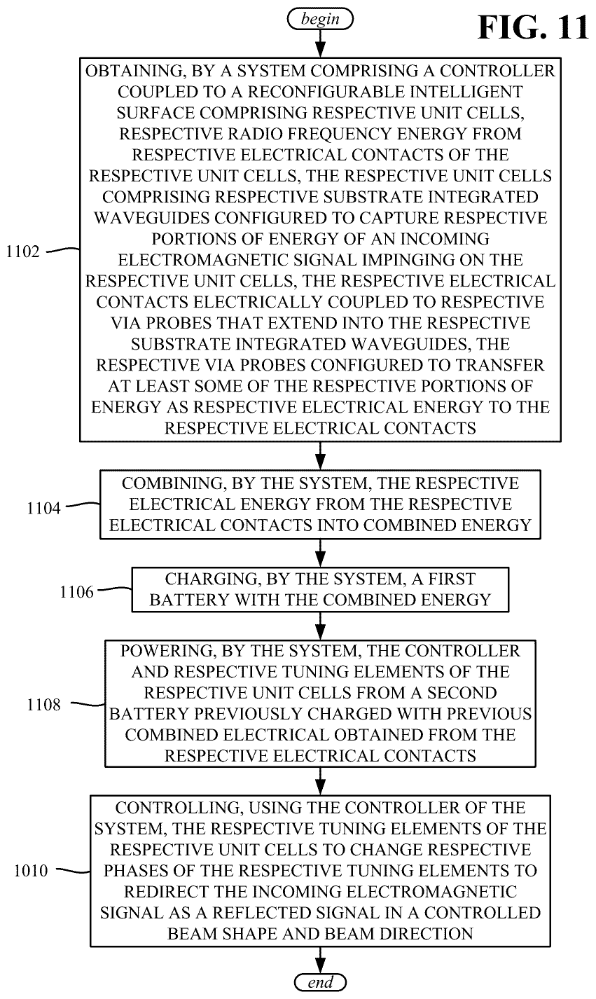

One or more example aspects, such as corresponding to example operations of a method, or a system/a machine-readable medium having executable instructions that, when executed by a processor, facilitate performance of the operations, are represented in FIG. 11. Example operation 1102 represents obtaining, by a system comprising a controller coupled to a reconfigurable intelligent surface comprising respective unit cells, respective radio frequency energy from respective electrical contacts of the respective unit cells, the respective unit cells comprising respective substrate integrated waveguides configured to capture respective portions of energy of an incoming electromagnetic signal impinging on the respective unit cells, the respective electrical contacts electrically coupled to respective via probes that extend into the respective substrate integrated waveguides, the respective via probes configured to transfer at least some of the respective portions of energy as respective electrical energy to the respective electrical contacts. Example operation 1104 represents combining, by the system, the respective electrical energy from the respective electrical contacts into combined energy. Example operation 1106 represents charging, by the system, a first battery with the combined energy. Example operation 1108 represents powering, by the system, the controller and respective tuning elements of the respective unit cells from a second battery previously charged with previous combined electrical obtained from the respective electrical contacts. Example operation 1110 represents controlling, using the controller of the system, the respective tuning elements of the respective unit cells to change respective phases of the respective tuning elements to redirect the incoming electromagnetic signal as a reflected signal in a controlled beam shape and beam direction.

Further operations can include switching, by the system, to charge the second battery with the combined energy, and power the respective tuning elements of the respective unit cells from the first battery.

Combining the respective electrical energy from the respective electrical contacts into the combined energy can include coupling the respective electrical energy from the respective electrical contacts to the first battery via a radio frequency combiner and a rectifier coupled to the battery.

Combining the respective electrical energy from the respective electrical contacts into the combined energy can include coupling the respective electrical energy from the respective electrical contacts to the first battery via a radio frequency combiner, an impedance matching circuit, and a rectifier coupled to the battery.

Further operations can include determining, by a power management device of the system, a first level of charge of the first battery and a second level of charge of the second battery, and, in response to the first level of charge satisfying a discharge threshold level, and the second level of charge satisfying a charge threshold level, switching, by the power management device, to charge the second battery with the combined energy, and to power the respective tuning elements of the respective unit cells from the first battery.

One or more example embodiments can be embodied in a system, such as described and represented herein. The system can include a reconfigurable intelligent surface of unit cells, a first battery, a second battery, electrical charging circuitry, and a power management device (module/unit). The power management device can be configured to select between a first operational state in which the first battery is coupled to the electrical charging circuitry for charging the first battery, and the second battery is coupled to provide power to the unit cells, and a second operational state in which the second battery is coupled to the electrical charging circuitry for charging the second battery, and the first battery is coupled to provide power to the unit cells. The unit cells (at least some) each can include a substrate integrated waveguide that obtains a portion of energy from an electromagnetic signal impinging on the unit cell, an energy harvesting contact coupled to the electrical charging circuitry, and a via probe extending into the substrate integrated waveguide to transfer electrical energy, based on the portion of energy obtained by the substrate integrated waveguide, to the energy harvesting contact for harvesting by the electrical charging circuitry.

The electrical charging circuitry can include a radio frequency power combiner, impedance matching circuitry and a rectifier.

The power management device can evaluate at least one of: a first level of charge of the first battery, or a second level of charge of the second battery; in response to at least one of: the second level of charge satisfying a discharge threshold level, the power management device can select the second operational state, or in response to the first level of charge satisfying a charge threshold level, the power management device can select the first operational state.

The system can further include a controller that controls respective variable tuning devices of respective unit cells of the unit cells; the first battery in the second operational state, and the second battery in the first operational state can provide power to the controller and to the respective variable tuning devices of the respective unit cells.

As can be seen, the technology described herein is directed to a reconfigurable intelligent surface arranged with unit cells that can extract a small portion of the energy of an incoming electromagnetic wave, with most of the incoming electromagnetic wave reflected to an intended target. The technology results in a self-sufficient operational model for a reconfigurable intelligent surface, eliminating (or at least substantially reducing) the need for power consumed from an external power source. The technology described herein thus significantly contributes to the advantage of reconfigurable intelligent surface technology's reduced power consumption when compared to traditional active relays.

For fully self-powered reconfigurable intelligent surfaces, such autonomous functionality can be particularly beneficial in various settings; for instance, in locations where power grids are unavailable or in situations where aesthetic considerations impede the installation of reconfigurable intelligent surfaces on certain structures, like trees. Moreover, aesthetic concerns can make it challenging to obtain permissions for installing external power cables on building exteriors to power the reconfigurable intelligent surfaces. Using large batteries as an energy source is also impractical, as they require ongoing maintenance and frequent replacement.

By utilizing the coupled electromagnetic waves from a substrate integrated waveguide for RF energy harvesting, an energy harvesting model is realized as described herein. The energy harvesting model includes RF combiner(s) that combine the coupled signals from multiple cells, followed by impedance matching circuit(s) (network(s)), after which the combined, impedance matched electromagnetic signal AC power is converted into DC power by a rectifying circuit of one or more rectifiers.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As used in this application, the terms “component,” “system,” “platform,” “layer,” “selector,” “interface,” and the like are intended to refer to a computer-related resource or an entity related to an operational apparatus with one or more specific functionalities, wherein the entity can be either hardware, a combination of hardware and software, software, or software in execution. As an example, a component can be an apparatus with specific functionality provided by mechanical parts operated by electric or electronic circuitry. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the various embodiments are not to be limited to any single implementation, but rather are to be construed in breadth, spirit and scope in accordance with the appended claims.

What is claimed is:

1. A system, comprising:
a reconfigurable intelligent surface that reflects an incoming electromagnetic signal as a reflected electromagnetic signal;
respective unit cells of the reconfigurable intelligent surface, the respective unit cells comprising:
respective substrate integrated waveguides configured to capture respective portions of energy of the incoming electromagnetic signal,
respective electrical contacts, and
respective coupling probes that extend into the respective substrate integrated waveguides to transfer electrical energy to the respective electrical contacts based on the respective portions of energy captured in the respective substrate integrated waveguides; and
electrical charging circuitry coupled between the respective electrical contacts and a battery, the electrical charging circuitry configured to convert the electrical energy from the respective electrical contacts to direct current that charges the battery.

2. The system of claim 1, wherein the battery is a first battery, and further comprising a controller, and a switch that is operational in a first state to couple the first battery to the electrical circuitry, in conjunction with a second battery providing power to the controller and to respective variable tuning devices of the respective unit cells, the respective variable tuning devices controllable by the controller to determine at least one of: shape, direction, or amplitude of the reflected electromagnetic signal.

3. The system of claim 2, wherein the switch is operational in a second state to couple the second battery to the electrical charging circuitry, in conjunction with the first battery providing power to the and the controller and to respective variable tuning devices of the respective unit cells.

4. The system of claim 1, wherein the battery is a first battery, and further comprising a switch that is operational in a first state to couple the first battery to the electrical circuitry, in conjunction with a second battery providing power to respective variable tuning devices of the respective unit cells, wherein the switch is operational in a second state to couple the second battery to the electrical charging circuitry, in conjunction with the first battery providing power to the respective variable tuning devices of the respective unit cells, and further comprising a power management device that toggles the switch between the first state and the second state based on a first level of charge of the first battery and a second level of charge of the second battery.

5. The system of claim 1, further comprising a power source that is coupled to a controller of the reconfigurable intelligent surface and to the respective variable tuning devices to act as a backup power source to the reconfigurable intelligent surface upon the first level of charge of the first battery satisfying a first discharge threshold level, and the second level of charge of the second battery first battery satisfying a second discharge threshold level.

6. The system of claim 1, wherein the electrical charging circuitry comprises a radio frequency power combiner comprising inputs electrically coupled to the respective electrical contacts.

7. The system of claim 6, wherein the electrical charging circuitry comprises an impedance matching circuit electrically coupled to an output of the radio frequency power combiner.

8. The system of claim 7, wherein the electrical charging circuitry comprises a rectifier coupled to an output of the impedance matching circuit.

9. The system of claim 8, wherein the rectifier is a multistage rectifier.

10. The system of claim 8, wherein the rectifier comprises a Dickson voltage rectifier.

11. The system of claim 7, wherein the rectifier comprises a fully depleted silicon-on-insulator rectifier.

12. A method, comprising:
obtaining, by a system comprising a controller coupled to a reconfigurable intelligent surface comprising respective unit cells, respective radio frequency energy from respective electrical contacts of the respective unit cells, the respective unit cells comprising respective substrate integrated waveguides configured to capture respective portions of energy of an incoming electromagnetic signal impinging on the respective unit cells, the respective electrical contacts electrically coupled to respective via probes that extend into the respective substrate integrated waveguides, the respective via probes configured to transfer at least some of the respective portions of energy as respective electrical energy to the respective electrical contacts;
combining, by the system, the respective electrical energy from the respective electrical contacts into combined energy;
charging, by the system, a first battery with the combined energy;
powering, by the system, the controller and respective tuning elements of the respective unit cells from a second battery previously charged with previous combined electrical obtained from the respective electrical contacts; and
controlling, using the controller of the system, the respective tuning elements of the respective unit cells to change respective phases of the respective tuning elements to redirect the incoming electromagnetic signal as a reflected signal in a controlled beam shape and beam direction.

13. The method of claim 12, further comprising switching, by the system, to charge the second battery with the combined energy, and power the respective tuning elements of the respective unit cells from the first battery.

14. The method of claim 12, wherein the combining of the respective electrical energy from the respective electrical contacts into the combined energy comprises coupling the respective electrical energy from the respective electrical contacts to the first battery via a radio frequency combiner and a rectifier coupled to the battery.

15. The method of claim 12, wherein the combining of the respective electrical energy from the respective electrical contacts into the combined energy comprises coupling the respective electrical energy from the respective electrical contacts to the first battery via a radio frequency combiner, an impedance matching circuit, and a rectifier coupled to the battery.

16. The method of claim 12, further comprising determining, by a power management device of the system, a first level of charge of the first battery and a second level of charge of the second battery, and, in response to the first level of charge satisfying a discharge threshold level, and the second level of charge satisfying a charge threshold level, switching, by the power management device, to charge the second battery with the combined energy, and to power the respective tuning elements of the respective unit cells from the first battery.

17. A system, comprising:
a reconfigurable intelligent surface of unit cells;
a first battery;
a second battery;
electrical charging circuitry; and
a power management device configured to select between:
a first operational state in which the first battery is coupled to the electrical charging circuitry for charging the first battery, and the second battery is coupled to provide power to the unit cells, and
a second operational state in which the second battery is coupled to the electrical charging circuitry for charging the second battery, and the first battery is coupled to provide power to the unit cells,
wherein at least some of the unit cells each comprise:
a substrate integrated waveguide that obtains a portion of energy from an electromagnetic signal impinging on the unit cell,
an energy harvesting contact coupled to the electrical charging circuitry, and
a via probe extending into the substrate integrated waveguide to transfer electrical energy, based on the portion of energy obtained by the substrate integrated waveguide, to the energy harvesting contact for harvesting by the electrical charging circuitry.

18. The system of claim 17, wherein the electrical charging circuitry comprises a radio frequency power combiner, impedance matching circuitry and a rectifier.

19. The system of claim 17, wherein the power management device evaluates at least one of: a first level of charge of the first battery, or a second level of charge of the second battery, wherein, in response to at least one of: the second level of charge satisfying a discharge threshold level, the power management device selects the second operational state, or in response to the first level of charge satisfying a charge threshold level, the power management device selects the first operational state.

20. The system of claim 17, further comprising a controller that controls respective variable tuning devices of respective unit cells of the unit cells, and wherein the first battery in the second operational state, and the second battery in the first operational state, provides power to the controller and to the respective variable tuning devices of the respective unit cells.
